(19) United States
(12) Patent Application Publication
(10) Pub. No.: US 2018/0144102 A1
(43) Pub. Date: May 24, 2018

(54) Generation of a Health Index for Financial Product Offerings

(71) Applicant: MASTERCARD INTERNATIONAL INCORPORATED, Purchase, NY (US)

(72) Inventor: Pravin Parekh, Pune (IN)

(21) Appl. No.: 15/789,729

(22) Filed: Oct. 20, 2017

(30) Foreign Application Priority Data
Nov. 21, 2016 (SG) 10201609737R

(51) Int. Cl. G06F 19/00; G06Q 30/02

(52) U.S. Cl. CPC G06F 19/3431; G06Q 30/0283; G06F 19/3481; G06F 19/328; G06F 19/322

(57) ABSTRACT

A method is proposed for calculating a heath index for an individual which is informative about the health of the individual. The health index is at least partly generated using transactional data specifying payment transactions made by an individual. Additionally, the calculation of the health index may use measurement data collected by a measurement device worn by the individual. The health index may be used to calculate a price for a financial product, such as an insurance product.

### CROSS-REFERENCE TO RELATED APPLICATION

This application claims the benefit of and priority to Singapore Patent Application No. 10201609737R filed Nov. 21, 2016. The entire disclosure of the above application is incorporated herein by reference.

### FIELD

The present disclosure relates to a computer system, a computer-implemented method and a computerized network for generating a health index indicative of the present or future health of an individual. The health index may be used in deriving a parameter of a financial product to be offered to the individual.

### BACKGROUND

This section provides background information related to the present disclosure which is not necessarily prior art.

Many financial products are characterized by a parameter which is dependent on the health characteristics of an individual to whom the financial product is offered. For example, the annual annuity which an annuity product pays senior citizens may be higher if they have a medical history statistically associated with shorter longevity. In another example, the price of life insurance and health insurance is sometimes higher for individuals with a poor medical history.

The same applies to financial products which are associated with insurance even if they are not primarily an insurance product. For example, certain loan products, such as real estate mortgage products, and certain saving products, are associated with an insurance product. In the case of a mortgage product for an item of real estate, the insurance may discharge the mortgage automatically if the mortgager dies or suffers a critical illness. When these financial products too are offered to an individual, a parameter (e.g., the interest rate) of the financial products may take into account the medical history of the individual.

Selecting parameters of financial products by taking into account health characteristics of individuals (rather than based on statistical health and longevity characteristics of entire communities) helps to reduce subsidies which healthy individuals would otherwise be effectively paying to less healthy individuals. These effective subsidies deter apparently healthy individuals from obtaining certain financial products, e.g., sometimes young people do not take out private health insurance because they calculate that the premiums amount to a subsidy of older insured individuals. Unfortunately, by not taking up those financial products, the apparently healthy individuals expose themselves to a higher level of risk.

It would thus be desirable for parameters of financial products to be selected so as to take into account more accurately the likelihood of individuals' future health.

### SUMMARY

This section provides a general summary of the disclosure, and is not a comprehensive disclosure of its full scope or all of its features. Aspects and embodiments of the disclosure are set out in the accompanying claims.

The present disclosure aims to provide new and useful computer-implemented methods, computer systems and computerized networks, for generation of a health index indicative of individuals' health.

In general terms, the disclosure proposes that transactional data specifying payment transactions made by an individual is used to obtain a health index which is informative about the health of the individual, in the sense of being statistically associated with the present and/or future health of the individual.

The health index may be used to select at least one parameter of a financial product (e.g., an insurance product, another financial product associated with an insurance product, or a savings product) to offer to the individual. For example, the parameter may be a price or interest rate for the financial product.

The disclosure is motivated by the observation that certain payment transactions are to purchase products associated with poor health (e.g., fast food or tobacco products). That is, those products are associated, at least statistically, with unhealthy lifestyle choices. In other words, they are associated, at least statistically, with reduced longevity and/or increased incidence of certain diseases. Thus, if payment transactions in which those products are purchased are identified, they should provide statistically relevant information to assist in the calculation of the health index.

Such payment transactions give clues to future health problems even for individuals who are too young to have yet experienced the medical problems associated with the unhealthy lifestyle choices. Furthermore, information about an individual's payments transactions may be available even in situations in which medical history is unavailable or unreliable (for example, because the individual does not give accurate information about his or her medical history).

In one example, the payment transactions associated with unhealthy lifestyle choices may be identified as payments to merchants who have previously been identified as selling predominantly unhealthy products. For example, individuals who frequently make payment transactions to merchants which supply unhealthy food (e.g., fast food) are statistically more likely to suffer health problems.

In another example, the transactional data may comprise product level data characterizing the product(s) which were purchased in the transaction. The inclusion of product level data is already standard in transactional data for payments for hotels, flights and car rental, and is expected to become increasingly common in the future. If the product level data indicates that an individual purchases products statistically associated with poor health (for example, unhealthy foods or unhealthy drinks (such as alcohol), tobacco products or even medicines), this information can be used to make the health index more accurate.

Conveniently, the calculation of the health index may be done by a health index calculation server which receives either the transactional data, or payment characterization data derived from the transactional data, from a second server. The second server may be one which is operative to perform a conventional process for handling transactional data. For example, it may be a payment network server which operates a payment card network, or a server of a bank which issues payment cards.

The health index may be generated further employing measurement data obtained by measurements carried out of the physical properties of the individual. Such data may be obtained by a measurement device carried (e.g., worn) by the individual. The measurement device may be a communication device enabled to access a telecommunications network (e.g., the measurement may be the user's phone or a smart watch). Alternatively, the measurement device may use a communication device associated with the individual to relay data to the health index calculation server, optionally with some pre-processing in the mobile phone.

In one case, the measurement data could be generated by a motion sensor in the device, characterizing physical activity of the respective individual. Alternatively or additionally, the device may include sensors (e.g., heart sensors, breathing sensors, blood sensors, thermometers, etc.) for measuring physiological properties of the body of the individual (e.g., heart, breathing rate and/or body temperature).

In some forms, the health index would employ pre-existing health guidelines descriptive of a healthy lifestyle (such as guidelines issued by the provider of a financial product). The health index could be calculated by a process comprising comparison of the measurement data with the health guidelines, or with exercise goals derived using the guidelines. For example, the health index could be reduced if the amount of physical activity specified by the measurement data is below a desirable level specified by the health guidelines.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Furthermore, the “payment card” may exist only as a data structure (i.e., without physical existence), which is registered with a digital wallet or cloud wallet.

As used in this application, the terms “component,” “module,” “engine,” “system,” “apparatus,” “interface,” or the like, are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The term “product” is used to include both goods and services. Typically, the products associated with poor health will be goods. The term “merchant” is used to be an organization which supplies products in return for payments.

The claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a tangible computer-readable medium (data storage device) embedded with a non-transitory computer-executable program, which encompasses a computer program accessible from any computer-readable storage device or storage media. For example, computer readable media can include, but are not limited to, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

An example embodiment of the disclosure will now be described, for the sake of example only, with reference to the following drawings, in which:

FIG. 1 shows a computerized network which is an embodiment of the present disclosure;

FIG. 2 shows a method which is an embodiment of the disclosure, and which is performed by a health index calculation server of the computerized network of FIG. 1;

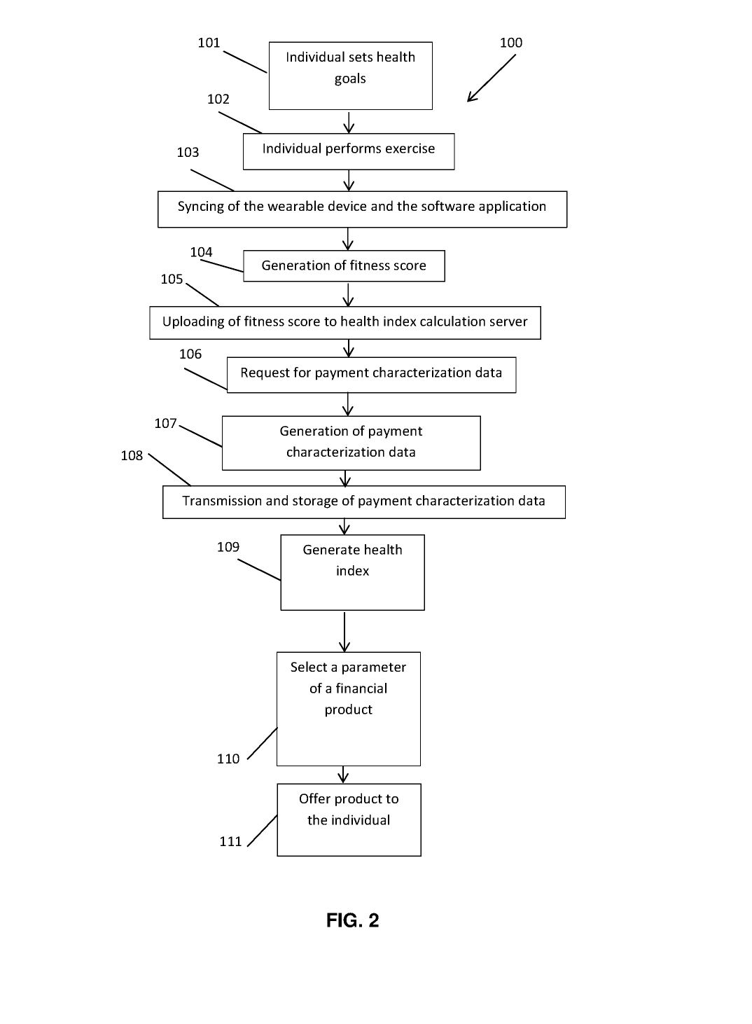

FIG. 3 shows schematically the technical architecture of servers of the computerized network of FIG. 1; and

FIG. 4 shows schematically the technical architecture of a communication device of the computerized network of FIG. 1.

Corresponding reference numerals indicate corresponding parts throughout the several views of the drawings.

### DETAILED DESCRIPTION

Embodiments of the present disclosure, again, will be described, by way of example only, with reference to the drawings. The description and specific examples included herein are intended for purposes of illustration only and are not intended to limit the scope of the present disclosure.

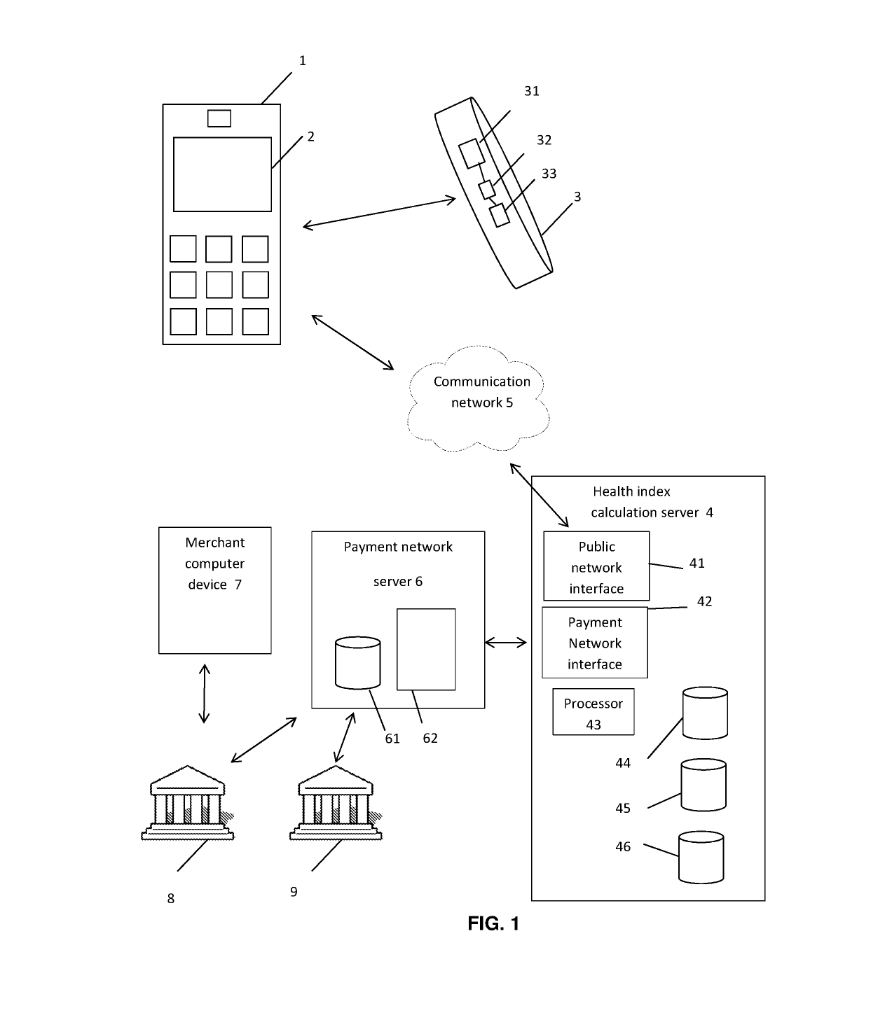

Referring firstly to FIG. 1, a computerized network is shown which is an embodiment of the disclosure. The network includes a mobile communication device 1 having a screen 2. The mobile communication device 1 is associated (e.g., owned by or habitually used by) an individual.

The individual is also associated with a wearable device 3 which may be a wrist band. The wearable device 3 includes a motion sensor 31 and at least one physiological sensor 33 for measuring a physiological parameter of the individual. For example, the at least one sensor 33 may be a heart rate sensor. Measurement data from the motion sensor 31 and the at least one physiological sensor 33 is collected by a control unit 32.

The control unit 32 includes a transceiver which is operative for two-way communication with the communication device 1. The communication is managed by a software application which is installed on the communication device 1. The individual may use the communication device 1 to control the timing of the communication between the control unit 32 and the communication device 1. The control unit 32 transmits the measurement data received from the motion sensor 31 and the at least one physiological sensor 33 to the communication device 1. Optionally, a processor of the wearable device 3 may perform some pre-processing of the measurement data before it is transmitted to the communication device 1. Thus, when the wearable device 3 is worn by an individual, it measures and transmits measurement data in the form of motion data measured by the motion sensor 31 and physiological data measured by the sensor(s) 33, to the communication device 1.

Although only one communication device 1 and wearable device 3 are shown, both associated with a single individual, it is envisaged that the computerized network will include a large number (e.g. at least many thousand) of communication devices and wearable devices. Each of a large number of individuals is associated with a respective one of the communication devices and a respective one of the wearable devices. The following description describes the operation of the computerized network in relation to the single individual associated with the devices 1, 3, but it is to be understood the multiple instances of the method will be performed substantially simultaneously for different respective individuals.

The computerized network further includes a health index calculation server 4. The health index calculation server 4 includes a public network interface 41 which is operative to communicate with the communication device 1 over a communication network 5 which may be the internet or a telephone system. The health index calculation server 4 may be operated by a financial organization, such as an insurance provider, which offers financial products to individuals.

The health index calculation server 4 further includes a payment network interface 42 for communicating with a payment network server 6 which operates a payment card network. The payment card network operates in a conventional manner. When the individual wishes to use a payment card to make a payment to a merchant (“a payment transaction”) to purchase a product, the payment network server 6 arranges for a payment to be made from an issuing bank which issued the payment card, to an acquiring bank where the merchant maintains an account.

Specifically, when the individual wishes to make the payment to the merchant to purchase one or more products, the individual transmits payment card data specifying the identity of the payment card (e.g., a 16-digit permanent account number (PAN) of the card), to a computer device 7 associated with the merchant. The computer device 7 may be a point-of-sale (POS) device located at the premises operated by the merchant, or a server of an online store operated by the merchant. The merchant computer device 7 forwards the payment card details to an acquiring bank server 8 of the acquiring bank together with additional information, such as the amount of the payment. The additional information may also include product level data identifying the products which will be purchased in the payment transaction. This data may, for example, be in the form of SKU (stock keeping unit) data which identifies the products within an inventory management system. The acquiring bank server 8 of the acquiring bank forwards the information received from the merchant computer device 7 to the payment network server 6. The payment network server 6 saves the transactional data received from the acquiring bank server 8 of the acquiring bank in a transactional data database 61. It uses the payment card data included in the transactional data to identify the issuing bank for the payment card, and sends a message to an issuing bank server 9 of the issuing bank seeking authorization of the payment transaction. If the issuing bank server 9 replies with a message authorizing the transaction, the payment network server 6 relays this information to the acquiring bank server 8, which relays it to the merchant computer device 7. The issuing bank server 9 debits the payment amount (optionally plus a handling charge) to an account associated with the individual, and the acquiring bank server 8 credits the payment amount (optionally minus a handling charge) to the account associated with the merchant. The individual then receives the product. At some later time, typically during a clearing operation, the issuing bank makes a corresponding payment to the acquiring bank.

The payment network server 6 includes a data analysis module 62 which uses the transactional data stored in the database 61 to identify payment transactions which are associated with poor health. This is described in more detail below.

A method 100, which is an embodiment of the disclosure, will now be described.

In a first step 101, the individual controls an application on the communication device 1 to receive health guidelines set by the insurance provider. Typically the individual controls the application to obtain them from the health index calculation server 4. The individual enters data about themselves (such as gender, age and medical fitness), and data about their exercise preferences into the communication device 1. The communication device 1 then generates exercise goals based on the entered data and the health guidelines.

For example, the health guidelines may contain a plurality of health templates suitable for individuals with respective sets of characteristics (e.g., age, gender, level of health). The application uses the data the user entered about themselves to extract the correct template. Then, the application uses the data the user provided about their exercise preferences to generate exercise goals which are consistent with the template.

Suppose the individual is a male who is 30 years old with good medical fitness. The software application may accordingly identify a template relating to males in the age range 28-30 and with good fitness. The individual indicates that he enjoys walking and using a step machine, and additionally enjoys a run on Sunday. However, he does not like swimming (or does not have access to a swimming pool). Accordingly, the software application generates the goals shown in the first five rows of Table 1.

TABLE 1

| Activity | Monday | Tuesday | Wednesday | Thursday | Friday | Saturday | Sunday |
|---|---|---|---|---|---|---|---|
| Walking | 2 miles | 1 mile | 2 miles | 1 mile | 2 | 1 mile | — |
| | | | | | miles | | |
| Steps | 100 | 100 | 100 | 100 | 100 | 100 | — |
| Running | — | — | — | — | — | — | 2 miles |
| Swimming | — | — | — | — | — | — | — |
| % Results | 50% | 100% | 100% | 15% | 50% | 75% | 15% |
| achieved | | | | | | | |
| Fitness score | .5 | 1 | 1 | .15 | .5 | .75 | .15 |

| | |
|---|---|
| Weekly | (.5 + 1 + 1 + .15 + .5 + .75 + .15)/7 = 0.57 |
| health score | |

In step 102, the individual carries out an excise regime. The sensors 31, 33 capture measurement data, which is accumulated in the control unit 32.

In step 103, the individual arranges for communication between the software application and the control unit 32, so that the control unit 32 uploads the accumulated measurement data into the application (i.e., “syncs” the wearable device with the software application).

In step 104, the software application may use the portion of the measurement data generated by the motion sensor 31 to identify which sporting activity the individual carried out. It compares the identified activity to the goals, to generate a fitness score for the period. In the example of table 1, the software application determines (see row 6 of Table 1) that the user has achieved a certain proportion of the goals on each respective day of the week. This gives a corresponding fitness score for each day, as shown in row 7 of Table 1. By averaging a week of these fitness scores, the software application obtains a fitness score for the week, as shown in row 8 of Table 1.

In a variation of the embodiment, the fitness score may also be generated using measurement data generated by the physiological sensor 33, e.g., the fitness score may be lower if the physiological sensor 33 indicates that the individual had a high heart rate during the identified exercise.

In a further variation of the embodiment, the fitness score may alternatively or additionally be calculated based on determination by the software application of characteristics of the individual's sleep patterns, using the measurement data.

The fitness score may be displayed to the individual using the screen 2. The display may also show a comparison of the goals with what was achieved. The display may further include a display of information obtained from the health index calculation server 4, showing how many goals were achieved by other individuals, e.g., a community of which the individual is a member, and/or a comparison of the goals set by the other individuals with what the other individuals achieved. Displaying this data encourages the individual to exercise harder in the future.

In step 105, the software application uploads the fitness score to a processor 43 of the health index calculation server 4. This may be done on a periodic basis (e.g., daily or weekly). The processor 43 may store the fitness score in a database 44. Additionally, the individual uses the communication device 1 to pass the individual's payment card number (or an encrypted version of it) to the health index calculation server 4.

In step 106, the processor 43 uses the payment network interface 42 to communicate with the payment network server 6, and request from it payment characterization data describing payment transactions the individual has made indicative of poor health of the individual. The request includes the payment card number (or the encrypted version of it) transmitted in step 105.

In step 107, an analysis module 62 of the payment network server 6 analyses the transactional data in the database 61 to generate the payment characterization data. One possibility is to do this based on the identities of the respective merchant to whom each payment was made. An example is shown in Table 2. The analysis module 62 has access to a predetermined list of merchant codes associated with respective merchants who, according to research, sell junk food/fast food/unhealthy food. It may further include merchants who supply other products statistically associated with poor health, such as pharmacies and alcohol-vendors. Suppose that the merchant codes in the predetermined list are MCC 20, MCC50, MCC51, MCC 78, MCC90.

Row 2 of table 2 shows the merchant codes for all the payment transactions the user makes during a week. Row 3 shows the result of filtering these payment transactions using the predetermined list, i.e., identifying the payment transactions made to one of the merchants on the predetermined list. Row 4 shows a respective score calculated by the analysis module 62 for each of the days, based on the number of identified transactions. By taking the sum of these over the week, the analysis module generates, the payment characterization data shown in row 5, which is representative of the frequency of the identified transactions.

TABLE 2

| | Day | | | | | | |
|---|---|---|---|---|---|---|---|
| | Monday | Tuesday | Wednesday | Thursday | Friday | Saturday | Sunday |
| Merchant | MCC 17 | MCC 31 | MCC 53 | — | MCC | MCC 50 | MCC |
| codes of | | MCC 47 | | | 30 | MCC 90 | 17 |
| transactions | | | | | MCC | | |
| on day | | | | | 47 | | |
| Filtered | — | — | — | — | MCC | MCC 50 | — |
| transactions | | | | | 30 | MCC 90 | |
| Scoring | 0 | 0 | 0 | 0 | −1 | −2 | 0 |

Payment Characterization Data = −1 − 2 = −3

Note that if the transactional data in the database 61 includes product level data, the calculation of the payment characterization data may be more sophisticated. In other words, the payment characterization data may only be affected by a purchase if the product level data indicates that the purchased product was a product in a pre-defined category. For example, if a certain merchant is a supermarket, the analysis module 62 may use the product level data to filter the products purchased to identify ones associated with poor health (e.g., tobacco, alcohol or certain medicines), and generate the payment characterization data accordingly.

In step 108 the payment network server 6 provides the payment characterization data to the health index calculation server 4. The health index calculation server 4 stores the payment characterization data in a database 45.

In step 109, the processor 43 uses the fitness scores stored in the database 44, and the payment characterization data stored in the database 45, to generate a health index for the individual according to an algorithm. If the fitness scores stored in the database 44 are high (or low), the algorithm generates a correspondingly higher (or respectively lower) health index. If the payment characterization data stored in the database 45 indicates a high (or low) frequency of purchases associated with poor health, the algorithm generates a correspondingly lower (or respectively higher) health index. The processor 43 stores the calculated health index in the database 45.

In a variant of the embodiment, the health index may be calculated using additional data, such as additional data supplied by the individual. The additional data may, for example, include information characterizing the medical history of the individual.

In step 110, the processor 43 may use the health index to select at least one parameter of a financial product to be offered to the individual. For example, the parameter may be a price of the financial product. For example, if the financial product is an insurance product, a user with a higher health score is offered lower prices than an individual with higher prices. The algorithm for calculating the price structure may be based on results of empirical research to identify the statistical correlation of the health index with health outcomes in which an insurance claim can be made.

In step 111, the financial product according to the selected parameter is offered to the individual, for example, by the health index calculation server 4 sending a message to communication device 1.

Thus, the embodiment makes it possible to provide to individuals with a high health index any one of more of:

a) Better medical insurance coverage and premiums.

b) Lower interest rates for loan products and credit cards.

c) Higher eligibility for quick and more loans.

d) Higher credit card limits.

e) Better interest on savings such as fixed deposits.

Indeed, using the disclosure it is possible for a bank to screen individuals, and determine which individuals are to be offered a certain financial product. The financial product may, for example, be a current account or savings account (CASA) with a better interest rate which is offered only to individuals with a high health index. Note that those individuals will typically live longer, and thus bank with the bank for longer.

An additional benefit of the disclosure is that it gives individuals a financial incentive to improve their health score by improved exercise or lifestyle choices. Thus, the disclosure is expected to lead to the individuals being healthier than they otherwise would have been.

A number of variations of the embodiment are possible within the scope of the disclosure. For example, although the health index calculation server 4 and the payment network server 6 are separate in the embodiment, in a variation of the embodiment the functions of both are performed by a single computer server.

In another variation, the analysis of the measurement data obtained from the wearable device 3 may be performed entirely within the health index calculation server 4, with the communication device 1 being used just to upload the measurement data to the health index calculation server 4 and/or to download results of the analysis from the health index calculation server 4 for display to the individual using the screen 2.

In another variation, the communication device 1 and the wearable device 3 may be incorporated into a single device, such as a smart watch.

Furthermore, although in the embodiment step 110 is performed by the processor 43 of the health index calculation server 4, in a variation of the embodiment the health index calculation server 4 may transmit the health index to a computer operated by a separate organisation which provides financial product(s), and steps 110 and 111 may then be performed by the computer of the separate organisation.

Furthermore, the order of the steps may be different. For example, step 107 may be performed in advance of the other steps of the method, and the payment characterization data stored in the database 61 until it is requested by the health index calculation server 4.

In yet another variation, the analysis module 62 may be provided within the health index calculation server 4 rather than within the payment network server 6. In this case, step 106 is replaced by a request from the index calculation server 4 to the payment network server 6 for transactional data from the database 61; step 107 is replaced by a step of the payment network server 6 transmitting the transactional data to the index calculation server 4, which stores it in the database 45; and step 108 is replaced by a step of the analysis module generating the payment characterization data using the transactional data (this may be done in the same way that step 107 is performed in the explanation above).

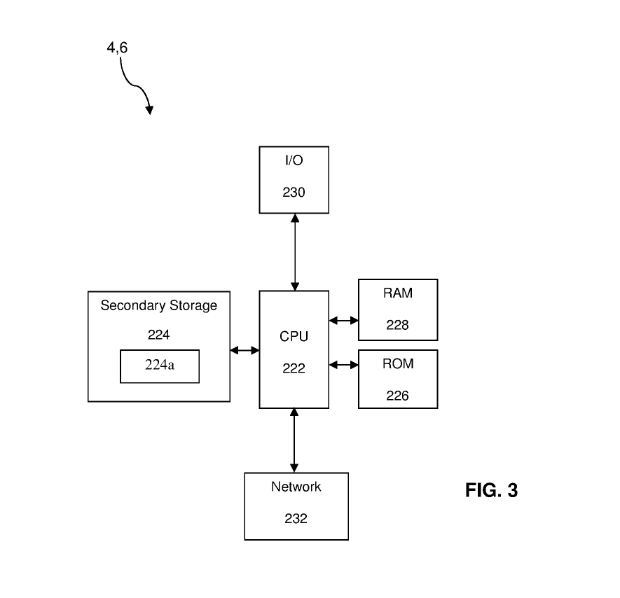

FIG. 3 is a block diagram showing a technical architecture of the health index calculation server 4. The payment network server 6 may also have this technical architecture.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols, such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

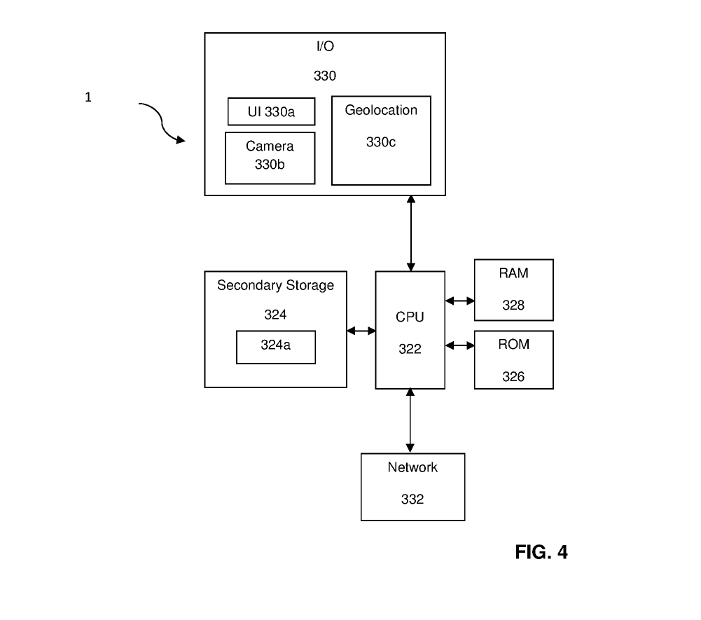

FIG. 4 is a block diagram showing a technical architecture of any one the communication device 1. It is envisaged that in embodiments, the communication device 1 will be a smartphone or tablet device.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices 330 comprise a user interface (UI) 330a, a camera 330b and a geolocation module 330c. The UI 330a may comprise a touch screen, keyboard, keypad or other known input device. The camera 330b allows a user to capture images and save the captured images in electronic form. The geolocation module 330c is operable to determine the geolocation of the communication device 1 using signals from, for example, global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present disclosure.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for forming a health index for an individual, the method comprising forming, by a computer system, the health index using payment characterization data, the payment characterization data characterizing payment transactions made by the individual that are associated with poor health of the individual.

2. The method according to claim 1, further comprising receiving measurement data describing measurements made of physical properties of the individual, and wherein forming the health index further includes employing the measurement data.

3. The method according to claim 2, wherein the measurement data comprises activity data, indicative of measured physical activity performed by the individual; and/or
wherein the measurement data comprises sensor data, indicative of the output of sensors measuring the state of the body of the individual.

4. (canceled)

5. The method according to claim 2, wherein the measurement data is data generated by a device carried by the individual.

6. The method according to claim 1, wherein forming the health index comprises forming a record descriptive of the individual during a period of time, and comparing that record with parameters set according to health guidelines.

7. The method according to claim 1, further comprising:
identifying, by the computer system, ones of the payment transactions associated with poor health of the individual based on transactional data describing the payment transactions made by an individual; and
generating the payment characterization data using the identified payment transactions.

8. The method according to claim 7, wherein the computer system comprises a payment card network server, configured to operate a payment card payment transaction process and collect the transactional data, and a second server for generating the health index; and
wherein the payment characterization data is indicative of the frequency of making the identified transactions.

9. (canceled)

10. The method according to claim 7, wherein identifying ones of the payment transactions associated with poor health of the individual comprises identifying payment transactions in which a payment is made to a predetermined list of merchants.

11. (canceled)

12. The method according to claim 7, wherein:
the transactional data includes product level data including a description of products purchased in the payment transactions; and
identifying ones of the payment transactions associated with poor health of the individual comprises using the product level data to generate product purchase data that characterizes the ones of the payment transactions involving products associated with poor health.

13. The method according to claim 12, wherein the payment characterization data characterizes the frequency with which the individual purchases products associated with poor health.

14. The method according to claim 1, further comprising selecting a parameter of a financial product to be offered to the individual based on a model employing the health index.

15.-22. (canceled)

23. A computer system for forming a health index for an individual, the computer system comprising:
at least one processor and at least one data storage device, the at least one data storage device storing computer instructions operative when performed by the at least one processor to cause the at least one processor to form the health index using payment characterization data, the payment characterization data characterizing payment transactions made by the individual and are associated with poor health of the individual.

24. The computer system according to claim 23, further comprising an interface for receiving measurement data describing measurements made of physical properties of the individual, and
wherein the program instructions are further being operative to cause the at least one processor to form the health index employing the measurement data.

25. The computer system according to claim 23, wherein the program instructions are further operative to cause the at least one processor to:
identify ones of the payment transactions associated with poor health of the individual based on transactional data describing the payment transactions made by the individual; and
generate the payment characterization data using the identified payment transactions.

26. The computer system according to claim 25, wherein the program instructions are operative to cause the at least one processor to identify the ones of the payment transactions associated with poor health of the individual by identifying payment transactions in which a payment is made to a predetermined list of merchants.

27. The computer system according to claim 25, wherein the program instructions are operable to cause the at least one processor to identify the ones of the payment transactions associated with poor health of the individual based on product level data comprised in the transactional data and describing products purchased in the payment transactions, and to generate product purchase data that characterizes the ones of the payment transactions involving products associated with poor health.

28. The computer system according to claim 23, wherein the program instructions are further operative to cause the at least one processor to select a parameter of a financial product using a model employing the health index.

29. A computer system for forming a health index for an individual, the computer system comprising:
at least one processor and at least one data storage device, the at least one data storage device storing computer instructions operative when performed by the at least one processor to cause the at least one processor to:
identify payment transactions made by an individual and associated with poor health of the individual based on transactional data describing the payment transactions; and
generate payment characterization data for the individual using the identified payment transactions.

30. The computer system according to claim 29, wherein the program instructions are operative to cause the at least one processor to identify the payment transactions associated with poor health of the individual by identifying payment transactions in which a payment is made to a predetermined list of merchants.

31. The computer system according to claim 29, wherein the program instructions are operative to cause the at least one processor to identify the payment transactions associated with poor health of the individual based on product level data comprised in the transactional data and describing products purchased in the payment transactions, and to generate product purchase data that characterizes the payment transactions involving products associated with poor health.

32.-34. (canceled)
